(19) United States
(12) Patent Application Publication
(10) Pub. No.: US 2016/0002482 A1
(43) Pub. Date: Jan. 7, 2016

(54) 6-COLOR SET PLUS ACHROMATIC(S) FOR SUBTRACTIVE COLOR COMBINATIONS

(71) Applicant: SUN CHEMICAL CORPORATION, Parsippany, NJ (US)

(72) Inventor: Paul A. Merchak, Loveland, OH (US)

(21) Appl. No.: 14/771,414

(22) PCT Filed: Mar. 14, 2014
(86) PCT No.: PCT/US2014/026997

§ 371 Date: Aug. 28, 2015

Related U.S. Application Data
(60) Provisional application No. 61/788,576, filed on Mar. 15, 2013.

(51) Int. Cl. C09D 11/40; C09D 11/037; B05D 5/06; B05D 1/28; B05D 1/32; B05D 1/02; G03G 9/09; B05D 1/00

(52) U.S. Cl. CPC C09D 11/40; G03G 9/0926; C09D 11/037; B05D 1/007; B05D 1/28; B05D 1/322; B05D 1/02; B05D 5/065

(57) ABSTRACT

A 6-Color Set of chromatic primary colors is disclosed containing a bordeaux and/or a yellow shade orange color but no magenta. A method of modifying the color gamut of a color application process is also presented.

### CROSS REFERENCE TO RELATED APPLICATIONS

This application claims priority to U.S. Provisional Patent Application Ser. No. 61/788,576 filed Mar. 15, 2013. All the applications are incorporated herein by reference in the entirety and for all purposes.

### FIELD OF THE INVENTION

The present invention relates to a six-Color Set of chromatic primary colors having a bordeaux color and/or a yellow shade orange color.

### BACKGROUND OF THE INVENTION

The selection of primary color to obtain desired color in a CMYKRGB apparatus was previously disclosed (Harold Boll, A Color to Colorant Transformation for a Seven Ink Process, presented at the IS &T-SPIE Symposium on Electronic Imaging, Science and Technology, SPIE vol. 2170, February 1994). The disclosed technique subdivides the gamut formed by the seven possible colorants into smaller groupings. A series of four-colorant subsets from the seven-ink superset of CMYKRGB are individually characterized and a colorimetric transform was obtained for each subset. In color space, each of the four-colorant subsets represents adjacent and overlapping subgamuts of the seven-colorant gamut.

The basic techniques of extending a CMYK printing process to a CMYKRGB printing process were previously reviewed (Ostromoukhov. “Chromaticity gamut enhancement by heptatone multi-color printing”, Proceedings of the SPIE, SPIE-Bellinghan, V A, vol. 1909, June 1993, pp. 139-151).

Popular techniques for gamut enhancement, particularly in regard to ink-jet printing were disclosed (“New Era of Digital Photo Printing . . . ”, Hard Copy Observer, October 1996, p. 1,). Some these techniques are using primary color inks of different densities (e.g. a dark cyan ink and a light cyan ink), or adding orange and green primary inks (this is known as the Pantone “Hexachrome®” system).

An experiment to determine the optimum colorant set beyond CMYK to maximize the printable gamut was described (J A Stephen Viggiano and William J Hoagland, “Colorant Selection for Six-Color Lithographic Printing,” Proceedings of the IST/SID 1998 Color Imaging Conference, p 112-115). The color gamut of a four-color printing process using CMYK is not very large and therefore some colors cannot be reproduced using only CMYK. Thus, processes using more than four inks have been developed in order to increase the color gamut. These additional inks are not “spot colors” used to create special effects, like luminescent inks. The additional inks are intrinsically part of the color separation process to create realistic images.

An example of printing with at least six inks is PANTONE's Hexachrome® system from PANTONE, Inc., Carlstadt, N.J., consisting of CMYK inks complemented with an Orange and a Green ink (CMYKOG). Another example is known as Küppers' ink set that uses CMYK, a Red, a Green, and a Blue ink (CMYKOGB) (H. Küppers: “Die Farbenlehre der Fernseh-, Foto- and Drucktechnik”, Du Mont Verlag., Köln, 1985).

U.S. Pat. No. 7,871,467 discloses an ink set for ink jet recording using CMY plus a green consisting specifically of C.I. Pigment Green 7 or C.I. Pigment Green 36 and an orange specifically consisting of C.I. Pigment Orange 43, C.I. Pigment Orange 64 and C.I. Pigment Orange 71.

U.S. Pat. No. 8,016,931 discloses an ink set using CMY plus two inks having hue angle from 0° to 80°, with both having higher saturation than the magenta, and with one having higher brightness and the other having lower brightness. Examples of lower brightness pigments include C.I. Pigment Red 177 and C.I. Pigment Red 179, a maroon.

U.S. Pat. No. 6,152,999 discloses a color ink jet ink set using CMY plus an orange, green or violet, where the cyan is a bridged aluminum phthalocyanine, the magenta is a quinacridone and the yellow is a non-benzidene. In addition to a magenta a violet includes the benzimidazolone C.I. Pigment Violet 32 and an orange includes a C.I. Pigment Orange 62.

U.S. Pat. No. 5,734,800 discloses a printing system for high fidelity printing of an image, comprising: a print grid including a combination of the color black and five basic ink colors, three to five of which having a predetermined portion of fluorescence. The non-fluorescent colors are selected from a group consisting essentially of PANTONE Yellow, PANTONE Yellow 012, PANTONE Yellow 013, PANTONE Process Yellow, PANTONE Orange 021, PANTONE Warm Red, PANTONE Red 032, PANTONE Red 033, PANTONE Rubine Red, PANTONE Magenta 052, PANTONE Process Magenta, PANTONE Rhodamine Red, PANTONE Purple, PANTONE Violet, PANTONE Violet 063, PANTONE Blue 072, PANTONE Reflex Blue, PANTONE Process Cyan, PANTONE Process Blue, PANTONE Blue 082, PANTONE Green, and PANTONE Green 092, while the fluorescent colors are selected from a group consisting essentially of PANTONE Fluorescent Blue 801, PANTONE Fluorescent Green 802, PANTONE Fluorescent Yellow 803, PANTONE Fluorescent Orange 804, PANTONE Fluorescent Warm Red 805, PANTONE Fluorescent Magenta 806, and PANTONE Fluorescent Purple 807.

U.S. Pat. No. 5,870,530, U.S. Pat. No. 5,751,326 & U.S. Pat. No. 8,054,504 disclose systems for printing and color separation processes.

U.S. Pat. No. 6,530,986 discloses aqueous ink sets of 5 or more inks that include CMYGO, where the cyan is a phthalocyanine, the magenta is a quinacridone, the yellow is C.I. Pigment Yellow 155, the green is selected from C.I. Pigment Green 7, 36 or mixtures, and the orange is from C.I. Pigment Orange 34, 36, 43, 61, 64, 71 or mixture.

US Patent Publication No. 2006/068084 discloses using two inks of the same color with one pigment and the other dye based, where they are opposite shades of the color i.e., reddish and greenish yellow, violet and reddish magenta, and greenish and bluish cyan.

U.S. Pat. No. 8,088,207 discloses an eleven color set using CMYK with an additional quinacridone magenta, two oranges, two purples, and two greens.

U.S. Pat. No. 5,309,246 discloses a technique for generating additional colors in a halftone color image through use of overlaid primary colored halftone dots of varying size, discloses a method for achieving an extended gamut of color by printing halftones with varying solid ink density. Such variable density CMYK primaries would not be used to produce a balanced neutral appearance but would be used to produce overprints with higher chroma or unique hue compared to standard CMYK overprints.

U.S. Pat. No. 5,689,349 discloses a method and a device for generating printing data in a color space defined for non-standard printing inks and describes how Pantone PMS® color can be substituted for one of the four standard process colors (CMYK) but discloses nothing regarding combining spot colors and process colors.

U.S. Pat. No. 5,734,800 teaches that the gamut of four standard process colors (CMYK) can be expanded by adding two additional process colors (OG), known commercially as Pantone Hexachrome.

U.S. Pat. No. 5,751,326 describes a method for converting a scanned image in RGB space into a set of printing forms for a process ink set comprised of CMYKRGB inks. However, no mention is made as to how to convert an extended gamut process set into a spot color, or how to incorporate a spot color into an extended gamut process set. The process primaries are defined by reference to specific Pantone® PMS® color swatches.

U.S. Pat. No. 5,812,694 describes a colorant selection algorithm for a color reproduction device. The algorithm looks at a range of primary colors and selects all reasonable subsets of those primaries to yield the most stable match to a given spot or line color, a step used in producing the printing forms required to reproduce a spot color using a process set. However, once again, there is no discussion as to how to use a spot color as a substitute or extension to a given process color set.

U.S. Pat. No. 5,870,530 describes the use of a secondary set of process primaries in an extended gamut 7 color process set to enhance the gamut of the CMYK ink primaries by overprinting with the extra process ink set. The system is used to create printing forms that “fill” in the process regions of color space between the C and Y with overprints of the G process primary. It does not teach how to match spot colors with process colors or how to incorporate a spot color into the extended gamut process ink set. The printing form is a virtual form as the preferred embodiments are for digital electrophotographic printing devices.

U.S. Pat. No. 5,892,891 describes an exact algorithm for six or seven color process printing. Additionally, this patent describes how to reduce the number of process primaries from six or seven to multiple subsets of four inks so that traditional color separation techniques may be applied to creating the printing form. It does not however describe using spot colors in the process set.

U.S. Pat. No. 6,307,645 describes a method for creating halftone screens for a six or seven color process set. It teaches how to print more than four primary inks without the need for additional halftone screening requirements by assigning one or more the screening properties of the CMYK ink set to the extra inks when used in combinations four inks at a time. Again, it does not describe spot colors or substituting spot colors into the process set. The described method suffers from the restriction that it is based on the use of virtual printing forms, as used in digital electrophotographic printing, where screen properties can be changed via digital computer codes. In a traditional packaging printing application using offset, flexographic or gravure printing technology, the printing form is fixed for all print regions. Thus, for example, the 0 ink may use the M screen in one area of the image being printed and the C screen in a different area of the same image. While this is achievable in digital printing, it is simply not possible in conventional printing.

U.S. Pat. No. 6,530,986 discloses a set of six inks for inkjet printing based on pigments with improved light fastness and an extended gamut over traditional CMYK ink sets.

U.S. Pat. No. 6,637,851 describes another form of color separation algorithm using digital image data in place of the traditional continuous tone image data. The described technique relates to taking the process ink sets in pairs and statistically distributing the color over a predetermined area of the image, in a process known as super pixilation or dithering. This is a process used in traditional packaging known as FM screening and has been incorporated in trademarked processes such as, for example, FMsix®.

US Patent Publication No. 2004/0114162 and EP 1364524 describe the FMsix printing process in which spot colors are matched with a hi-fi process set in which (i) the photographic image data are printed using traditional CMYK halftoning and (ii) logos and brand colors are printed using the extended gamut printing set and digital frequency modulation halftoning. The method is said to reproduce with an accuracy of 6 CIELAB color difference units 85% of all known spot colors. It does not teach the use of spot colors as the secondary set of extended gamut colors.

U.S. Pat. No. 7,123,380 describes the conversion of a color in an image defined in a 3 or 4 dimension color space (RGB or CMYK) into a color space defined by more than 4 dimensions or colorants. This is a color separation process that is based on mapping the gamut of colors of one color space into or onto the gamut of colors of the second and third color spaces. This approach is used to take a traditional CMYK image and move it to a digital proofing device that uses more than 4 primary colors to obtain a larger gamut for proofing. The described method does not discuss matching spot colors or using spot colors as the extended gamut colors.

U.S. Pat. No. 7,164,498 describes taking an RGB image and mapping it onto multiple output devices utilizing a variation of the ICC profile method. It is primarily a method for digital color separation involving a “Virtual CMYK” profile. This concept defines a printing system with an ideal, unattainable CMYK color gamut which is larger than either of the real CMYKOG or CMYKRGB extended gamuts. Then, gamut compression is used to map the unreal CMYK onto the real extended gamut process primary set. No description is provided regarding spot colors or using spot colors in the process set.

U.S. Pat. No. 7,199,903 describes a method for numerical prediction of the color and appearance of a series of overprinted process primaries. This teaching applies to creating a printing form that produces a combination of a range of process inks that will reproduce a desired color on a printing device. The teaching does not disclose or identify the matching of spot colors or the use of spot colors in the process set, though the techniques disclosed here could be useful in providing the definition of the print forms required to do so.

U.S. Pat. No. 7,535,596 describes a method for determining colorant control values for a color imaging device having four or more colorants is disclosed. The method includes defining a color mapping for a set of paths through a three-channel color space, defining a color mapping function for the three-channel color space relating the three-channel color space values to colorant control values for the four or more colorants of the color imaging device by interpolating between the color mapping defined for the set of paths, forming a forward three-channel color model relating the three-channel color space values to device-independent color values, inverting the forward three-channel color model to determine an inverse three-channel color model relating the device-independent color values to the three-channel color space values, and combining the inverse three-channel color model and the color mapping function to determine an inverse device color model.

U.S. Pat. No. 7,898,692 discloses a method and apparatus for moiré-free color halftone printing with up to five color image separations. The method and apparatus utilize a plurality of non-orthogonal halftone screens to produce outputs that are moiré free and form rosettes. The method and apparatus provide for defining a first and a second color halftone screen fundamental frequency vector for each of three halftone screens such that the halftone screen set output forms moiré-free rosettes; then defining a fourth color halftone screen where a first fundamental vector of the fourth screen shares a fundamental frequency vector with one of said three halftone screens and a second fundamental frequency vector of the fourth screen shares a fundamental frequency vector with a different one of said three color halftone screens; and further defining a fifth color halftone screen where a first fundamental vector of the fifth screen shares a fundamental frequency vector with one of said three halftone screens and a second fundamental frequency vector of the fifth screen shares a fundamental frequency vector with a different one of said three color halftone screens, and the neither of the fundamental frequency vectors of the fifth screen are equal to either of the fundamental frequency vectors of the fourth screen.

U.S. Pat. No. 7,990,592 discloses methods, systems and apparatus to manage spot colors for an image marking device. Specifically, disclosed is a spot color control method including selecting a gain matrix K from a plurality of gain matrices. The gain matrix K is selected to satisfy performance criteria associated with the rendering of the target spot color. The performance criteria includes an acceptable spot color error associated with the rendered spot color relative to the target color and an acceptable actuator energy utilized to achieve the acceptable spot color error and a total toner/ink usage acceptable to render the spot color.

### SUMMARY OF THE INVENTION

The present invention provides a 6-Color Set of chromatic primary colors comprising:

(a) a bordeaux color and/or a yellow shade orange color; and

(b) a number of other colors in order to have a total of 6 colors in the set,

wherein magenta is not one of the chromatic primary colors and the 6-Color Set is suited for subtractive color combinations.

The present invention also provides a color application process comprising generating various colored materials using the 6-Color Set of the present invention.

The present invention further provides an article prepared using the 6-Color Set of the present invention.

The present invention also provides a method of modifying the color gamut of a color application process that employs a 6-Color Set of chromatic primary colors comprising modifying the 6-Color Set to exclude magenta color and add a bordeaux color and/or a yellow shade orange color.

These and other objects, advantages, and features of the invention will become apparent to those persons skilled in the art upon reading the details of the methods and formulations as more fully described below.

### BRIEF DESCRIPTION OF THE DRAWING

FIG. 1 shows a standard set of primary colors, generally called cyan, magenta, yellow (CMY) projected onto a color space diagram.

FIG. 2 shows a standard set of primary colors, generally called cyan, magenta, yellow, red, green and blue (CMYRGB) projected onto a color space diagram.

FIG. 3 shows the plots of three actual 6-color ink sets.

FIG. 4 shows the spectral responses for a 6-color ink set of the present invention with Bordeaux as a primary color.

FIG. 5 shows the incremental spacing in the spectral responses for fourteen pigments of various shades of colors that are obtained when transitioning from C.I. Pigment Yellow 213 on the left to C. I. Pigment Red 49:2 on the right from a yellow of a greener shade to a Bordeaux, respectively. The order in the figure legend from top to bottom correlates with the order for the various “S” shaped curves from left to right.

FIG. 6 shows a typical spectral response feature of many colorants, in particular various C.I. Pigment Yellow, C.I. Pigment Orange, C.I. Pigment Red, and C.I. Pigment Violet pigments, which is a common sigmoid shaped curve (also known as a “S” shape curve or “S” curve). The color for these colorants vary in shades for the broad color groups considered in the art as yellows, oranges, reds, magentas and even some purples and violets. There are numerous common names and designations within each group that provide subsets within these broad classes of colors, for example a few of the many names for reds but not limited to these include scarlet, blue shade, yellow shade, dark, maroon, carmine, sangria, vermillion, burgundy, firebrick, fire engine, candy apple and dark sienna.

FIG. 7 shows the wavelength wrossing MP % R for various colorants having linear functions with optical density used to calculate the MPW. The order in the figure legend from top to bottom correlates with the order of the data from top to bottom. The colorant are various pigment types labeled as R49:2 for C.I. Pigment Red 49:2, 036 for C.I. Pigment Orange 36, Y17 for C.I. Pigment Yellow 17 and so forth. The resulting colors from the particular colorants are also shown as Bordeaux, Magenta, Deep Hot Pink, Orange, YS Orange and three Yellows. The dashed and solid horizontal line sections of the rectangles show the ranges and preferred ranges for the bordeaux, deep hot pink, yellow shade orange and yellow colors. The vertical line sections of the rectangles show the printing OD range limits of 1.1 & 1.3 for extrapolating or interpolating the MPW at the centerline OD=1.2.

FIG. 8 shows the spectral response from Example 4 for the yellow, yellow shade orange, deep hot pink and bordeaux colors and the MPW preferred range for the colors. FIG. 8 also shows the Spectral Response for the Leneta substrate and the calculated MP % R values. The MPW for a colorant is the wavelength at which the “S” shade curve crosses the MP % R.

FIG. 9 shows the MPW ranges and the MPW preferred ranges for Yellow, Yellow Shade Orange, Deep Hot Pink and Bordeaux colors.

FIG. 10 shows the MPW ranges and preferred ranges and the spectral response for three Yellows of a greener, a medium and a redder shade, and one each for Yellow Shade Orange, Deep Hot Pink, and Bordeaux; and shows a spectral response for an Orange and a Magenta.

FIG. 11 shows the Sigmoid “S” shaped curves of C.I. Pigment Yellow 13(Yellow 13), C.I. Pigment Orange 72 (Orange 72) and Yellow 13/Orange 72 trap.

FIG. 12 shows the Sigmoid “S” shaded curves of C.I. Pigment Yellow 13(Yellow 13), C.I. Pigment Orange 16 (O16) and Yellow 13/Orange 16 trap.

FIG. 13 shows the Sigmoid “S” shaped curves of C.I. Pigment Yellow 13(Yellow 13), C.I. Pigment Orange 43 (Orange 43) and Yellow 13/Orange 43 trap.

FIG. 14 shows the Sigmoid “S” shaped curves of C.I. Pigment Yellow 13(Yellow 13), C.I. Pigment Red 22 (R22) and Yellow 13/Red 22 trap.

FIG. 15 shows the Sigmoid “S” shaped curves of C.I. Pigment Yellow 13(Yellow 13), C.I. Pigment Red 57:1 (Red 57:1) and Yellow 13/Red 57:1 trap.

### DETAILED DESCRIPTION OF THE INVENTION

The following color designations are referred to throughout the application: cyan (C), magenta (M), yellow (Y), black (K), red (R), green (G), blue (B), yellow shade orange (YS-O or YS orange), orange (O), violet (V), deep hot pink (D) and bordeaux (X).

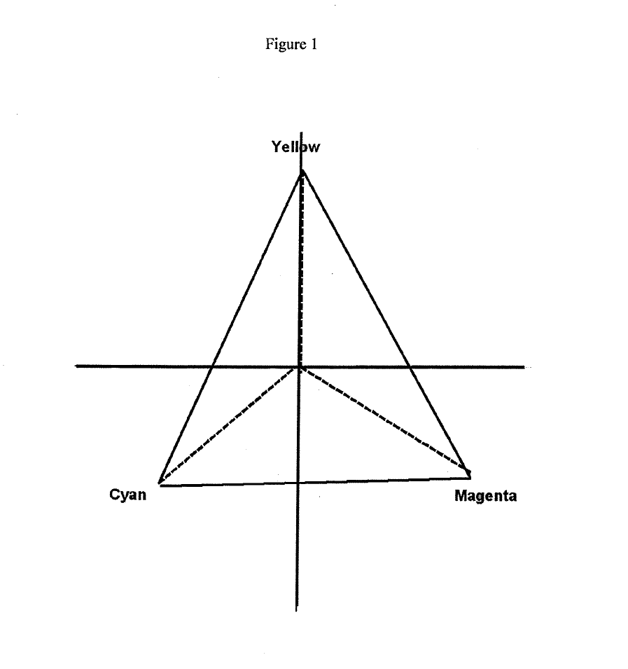

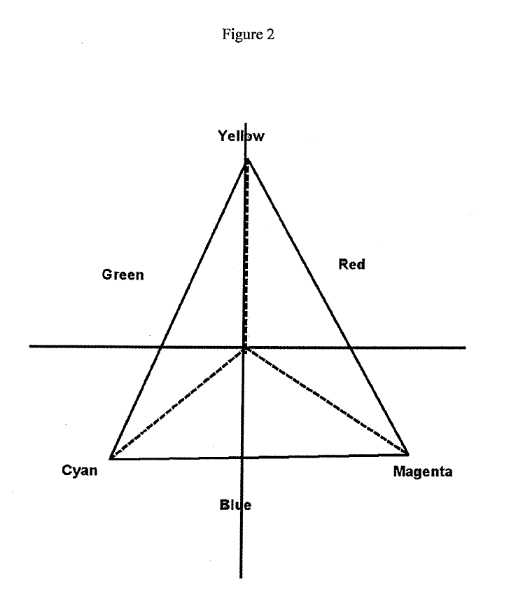

In the prior art, the development of an extended gamut color primary set usually begins with a standard set of primaries, generally called cyan, magenta, yellow (CMY) projected onto a color space diagram as illustrated in FIG. 1. An ideal set of primaries would form a perfect equilateral triangle in color space, indicating the path through color space which mixes of the full strength primaries will follow and defining the area inside of which all mixtures of the primaries with white and/or black will fill. This is known as the gamut of the primary set. As can be observed in FIG. 1, there are large regions of color space that lie outside of the gamut of colors achievable using mixes of the primaries with white and/or black. Consequently, it has been the desire of many to develop primary color sets that contain more than 3 primary colors which will produce a larger gamut area than the basic 3 primaries. This ideal is shown in FIG. 2, where the approximate locations of 3 additional primary colors are indicated, with the names Red, Green, Blue (RGB). Ideally, according to the prior art and especially the paper by Viggiano et al. (J A Stephen Viggiano and William J Hoagland, “Colorant Selection for Six-Color Lithographic Printing,” Proceedings of the IST/SID 1998 Color Imaging Conference, p 112-115), the additional primaries should be the geometric complement to the ideal set. And so Viggiano et al. identified the amount of gamut improvement achieved by adding a new primary color, one at a time, to the basic 3 primary colors.

Subsequent literature have all followed this concept with some primaries containing pigments that are fluorescent to achieve a cleaner, higher chroma color which would then be used to extend the gamut of the standard 3 primary colors and reclaim some of the unattainable regions of color space. Each of these disclosures have been somewhat successful in achieving this goal.

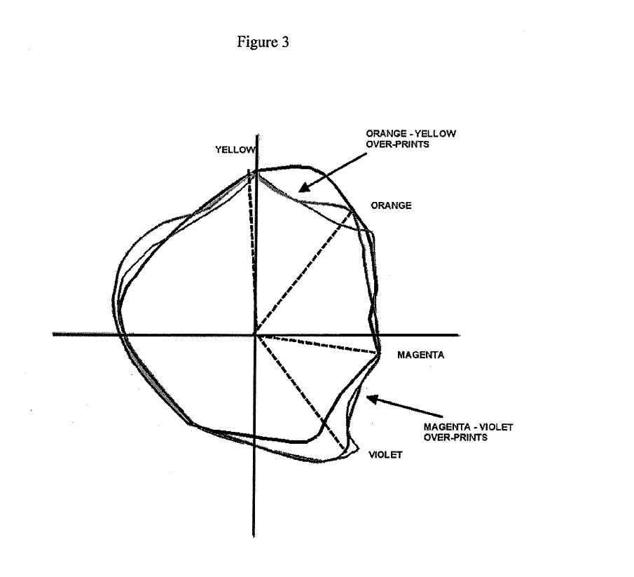

One of the reasons that the previous inventions have not been as successful as hoped is that the colors of real pigments and real inks or paints produced from those real pigments do not match exactly the locations of the ideal. Practical magenta, for example, lies very close to the horizontal a*axis in the CIELAB color space while cyan lies closer to the same horizontal a*axis on the negative side of the vertical or b*axis. But cyan and magenta are supposed to be complementary and this difference from ideal is due to undesirable or unwanted absorptions in the primary colors. This results in the mixtures of the primaries producing “dirty” or less “clean”, lower chroma colors than expected. This can be seen in FIG. 3 which shows the plots of three actual 6-color ink sets. It can be seen that all three ink sets produce mixtures of the magenta and violet primaries that are concave inward and the chroma of the mixture is lower or less clean than either of the individual primaries. Similarly, two of the ink sets produce mixtures of the orange and yellow primaries that are less clean while one ink set produces a color is cleaner than either of the two primaries. The prior art provides no clear explanation for this departure in spite of the lower chroma of the mixtures and, as a result, smaller gamut areas than anticipated.

The present invention provides a theoretical framework for why the inks sets proposed according the theory given in the prior art, failed to produce the full optimum gain in color space gamut and to propose a method for objectively defining the properties of primary colors that will produce that largest gamut area in color space and the highest chroma mixtures of those primaries.

Accordingly, the present invention provides an improved, more evenly spaced extended color gamut process ink set than other color sets. The spacing is based on the electromagnetic wavelengths rather than on the location of the primaries in perceptual color space. This provides overall cleaner, higher chroma, colors. The gamut of a process ink set is based partially on the perceptual distance from an achromatic color of the same lightness and partially on the spectral purity of the pigment transitions of the absorption bands of the colorants. The spectral purity is the major influence on color combinations or halftone builds, such as printing also known as trapping one or more colors over another, which when properly spaced results in overall cleaner and higher chroma colors. FIG. 3 shows an example of an extended process color set in which the spectra of the primaries are not properly spaced and the regions between primaries (the overprinted colors) shows a lower chroma than either of the two primary colors.

The present invention provides printers the ability to produce overall cleaner, brighter and more chromatic colors compared to traditional 3-color process printing and to other 6-color process printing primary ink sets.

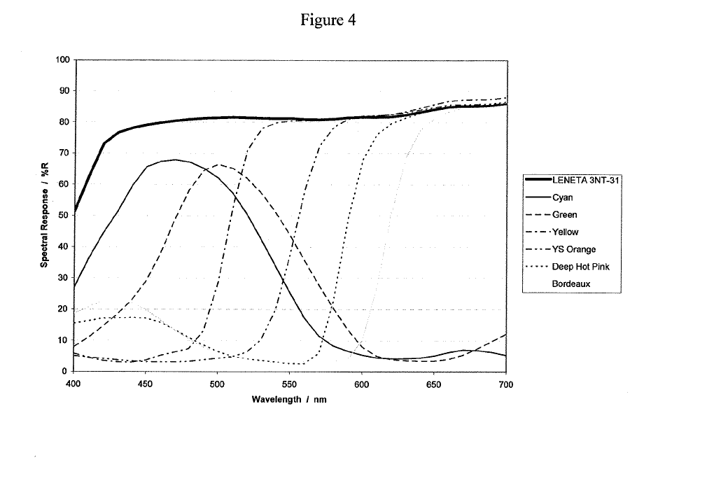

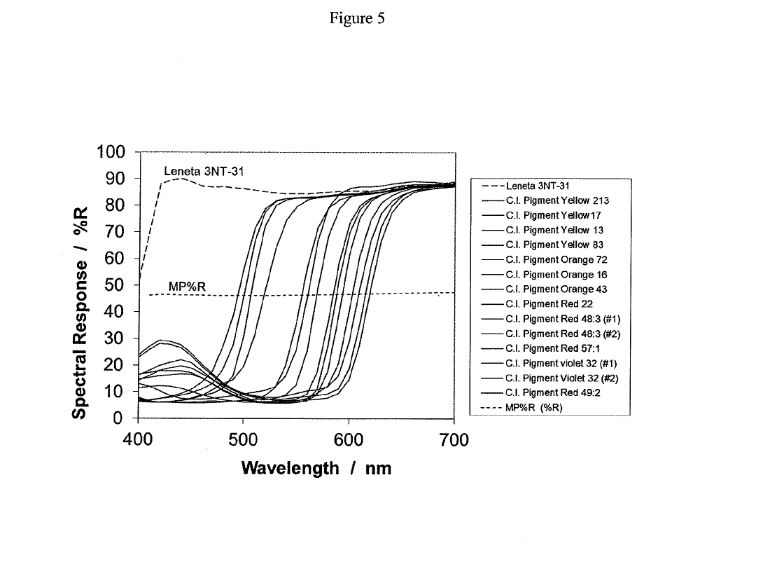

In one embodiment, the present invention relates to a 6-color printing ink set that includes a bordeaux colored ink preferably with more evenly spaced mid-point wavelengths (MPWs) than what is identified in the prior art. FIG. 4 shows the spectral responses for a six color ink set of the present invention. FIG. 5 shows the spacing in the spectral responses for fourteen pigments of various shades of colors that are obtained when transitioning from left to right in the graph and top to bottom in the legend from a green shade yellow to a bordeaux. The MPWs for the fourteen pigments shown in FIG. 5 and additional pigments are shown in Table 1.

TABLE 1
The mid-point wavelengths (MPWs) for various pigments.

| Pigment Type | MPW |
|---|---|
| Yellow (Y213) | 494.4 |
| Yellow (Y17) | 505.6 |
| Yellow (Y13) | 506.3 |
| Yellow (Y83) | 518.9 |
| YS Orange (O72) | 554.2 |
| YS Orange (O62) | 556.7 |
| YS Orange (O16) | 562.0 |
| YS Orange (O64) | 562.9 |
| Orange (O43) | 568.7 |
| Orange (O36) | 575.7 |
| Deep Hot Pink (R209) | 582.8 |
| Deep Hot Pink (R22) | 584.6 |
| Deep Hot Pink (R48:3 - #1 | 587.4 |
| Deep Hot Pink (R48:3 - #2) | 592.2 |
| Deep Hot Pink (R48:3 - #3) | 593.1 |
| Deep Hot Pink (R81:2) | 593.6 |
| Magenta (R57:1) | 602.8 |
| Magenta (R122) | 603.0 |
| Magenta (R147) | 604.1 |
| Magenta (R269) | 605.1 |
| Bordeaux (V32 - #1) | 611.1 |
| Bordeaux (V32 - #2) | 616.7 |
| Bordeaux (R63:1) | 619.4 |
| Bordeaux (R49:2) | 619.9 |

In another embodiment, the present invention relates to a six-color printing ink set that includes a yellow shade orange color with more evenly spaced mid-point wavelengths (MPWs) than what is disclosed in the prior art.

In yet another embodiment, the present invention relates to a six-color printing ink set that includes both a bordeaux and a yellow shade orange color with more evenly spaced MPWs than what is disclosed the prior art.

In another embodiment, the present invention relates to a six-color printing ink set that includes a bordeaux and/or a yellow shade orange color but excludes magenta, deep hot pink, a color having a Mid-Point Wavelength between 590 and 600 nm and/or any color having a Mid-Point Wavelength between 582 and 594 nm.

Preferably, the six-color printing ink set of the present invention further comprises one or more additional achromatic ink, where the achromatic ink is defined for the purpose of the present invention as being substantially white, gray or black.

Also preferably, the six-color printing ink set of the present invention provides clean red shades of yellow when trap printing the yellow and YS orange inks.

Again preferably, the six-color printing ink set of the present invention provides clean, high chroma dark reds when trap printing the bordeaux with the yellow shade orange and/or the yellow ink.

In one embodiment, the present invention relates to a six-color printing ink set where the spectral inflection points or the MPWs are relatively evenly separated from each other along the scale of wavelength compared to printing inks reported in the prior art. The separation between the MPW of two adjacent colors is calculated as the difference between the MPWs for the two colors. For example in Table 2 Example 1, the difference between the MPW (ΔMPW) for the yellow shade orange of 554.2 and the yellow of 506.3 is 47.9. Likewise the difference between the deep hot pink and yellow shade orange is 33.2. A large difference between the ΔMPWs for a color set shows that the MPWs vary greatly, while a small difference shows the MPWs are more evenly spaced. Accordingly, the present invention provides a color set where the difference between the maximum and minimum MPWs (ΔMPW(Max-Min)) of the various colors is less than or equal to 35, preferably it is less than 20 and more preferably it is less than 10. Table 2 shows three examples of the present invention. Table 3 provides examples of the prior art.

TABLE 2
6-Color sets of the present invention with indication of the
differences between the maximum and minimum MPWs (ΔMPW(Max −
Min)) of 4 colors with “S” shade curves and 2
colors with peak maximums as the predominant spectral feature.

| | MPW | | ΔMPW |
|---|---|---|---|
| Invention (Example 1) | | | |
| Bordeaux (V32) | 616.7 | Bordeaux to Deep Hot Pink | 29.3 |
| Deep Hot Pink (R48:3) | 587.4 | Deep Hot Pink to YS Orange | 33.2 |
| YS Orange (O72) | 554.2 | YS Orange to Yellow | 47.9 |
| Yellow (Y13) | 506.3 | ΔMPW(Max − Min) = | 18.6 |
| Green (G7) | Peak Maximum = 501 | | |
| Blue (B15:3) | Peak Maximum = 467 | | |
| Invention (Example 2) | | | |
| Bordeaux (R49:2) | 619.9 | Bordeaux to Deep Hot Pink | 32.5 |
| Deep Hot Pink (R48:3) | 587.4 | Deep Hot Pink to YS Orange | 33.2 |
| YS Orange (O72) | 554.2 | YS Orange to Yellow | 35.3 |
| Yellow (Y83) | 518.9 | ΔMPW(Max − Min) = | 2.8 |
| Green (G36) | Peak Maximum = 513 | | |
| Violet (V23) | Peak Maximum = 438 | | |
| Invention (Example 3) | | | |
| Bordeaux (R49:2) | 619.9 | Bordeaux to Deep Hot Pink | 32.5 |
| Deep Hot Pink (R48:3) | 587.4 | Deep Hot Pink to YS Orange | 33.2 |
| YS Orange (O72) | 554.2 | YS Orange to Yellow | 47.9 |
| Yellow (Y13) | 506.3 | ΔMPW(Max − Min) = | 15.4 |

| | |
|---|---|
| Green (G7) | Peak Maximum = 501 |
| Blue (15:6) | Peak Maximum = 454 |

TABLE 3
Color sets of the prior art with indication of the differences between
the maximum and minimum MPWs (ΔMPW(Max − Min)).

| | MPW | | ΔMPW |
|---|---|---|---|
| Prior Art (US 6152999) | | | |
| Bordeaux (V32) | 617 | Bordeaux to Magneta | 14 |
| referred to as | | | |
| violet in 6152999 | | | |
| Magenta (R122) | 603 | Magenta to YS Orange | 43 |
| YS Orange (O62) | 560 | YS Orange to Yellow | 55 |
| referred to as | | | |
| orange in 6152999 | | | |
| Yellow (Y74) | 505 | ΔMPW(Max − Min) = | 41 |
| Green (G7) | Peak Maximum = 501 | | |
| Cyan (Bridged | Peak Maximum = unknown (Would be ex- | | |
| aluminum | pected to be in the range from 470-485 | | |
| phthalocyanine) | knowing the materials involved.) | | |
| Prior Art | | | |
| Magenta (R57:1) | 603 | Magneta to Deep Hot Pink | 18 |
| Deep Hot Pink (R22) | 585 | Deep Hot Pink to YS Orange | 23 |
| YS Orange (O16) | 562 | YS Orange to Yellow | 56 |
| Yellow (Y13) | 506 | ΔMPW(Max − Min) = | 38 |

| | |
|---|---|
| Green (G7) | Peak Maximum = 501 |
| Violet (V23) | Peak Maximum = 438 |

In another embodiment, the present invention relates to a six color printing ink set where the colorant absorption bands are relatively evenly separated from each other.

The optical densities of the inks are defined by the absorption band of the colorants.

Also preferably, the six-color printing ink set of the present invention includes a bordeaux ink as the color with the highest inflection point or MPW

The color order defined as Blue (B), Green (G), Yellow (Y), Yellow Shade Orange (YS-O), Deep Hot Pink (D) and Bordeaux (X) or abbreviated as BGY(YS-O)DX represent a preferred 6-Color Set of the present invention. Adjacent colors are those next to each other in the color order for example green is adjacent to blue and yellow. In another preferred embodiment the color order defined as Cyan (C), Green (G), Yellow (Y), Yellow Shade Orange (YS-O), Deep Hot Pink (D) and Bordeaux (X) or abbreviated as CGYODX represent a 6-Color Set of the present invention. In another preferred embodiment the color order defined as Violet (V), Green (G), Yellow (Y), Yellow Shade Orange (O), Deep Hot Pink (D) and Bordeaux (X) or abbreviated as VGY(YS-O)DX represent a 6-Color Set of the present invention. In another preferred embodiment the color order defined as Violet (V), Cyan (C), Yellow (Y), Yellow Shade Orange (YS-O), Deep Hot Pink (D) and Bordeaux (X) or abbreviated as VCY(YS-O)DX represent a 6-Color Set of the present invention.

The colorant in the described inks may be dyes, pigments or a combination of these. The color provided by a colorant is determined not by the identifying name provided by the supplier but by the spectral response from the light reflected from the colorant in a film, which is characterized by two dominant features: a “S” shape curve with MPW ranging from approximately 480-630 nm or a peak with a maximum ranging from approximately 400-550 nm. The broad color groups described in the art as yellows, oranges, reds, magentas and even some purples and violets have a predominant “S” shape curve and the broad color groups described in the art as green, cyan, blue and some violet and purples have predominant peak maximums. Purple is not used in the present invention to define a color and violet is used to define a color in the present invention where the peak is predominant and any MPW if present is >630 nm. The position, breadth, symmetry, magnitude of the minimum and maximum, and other fine structural detail of both the “S” shape curve and peak provide further definition of the resulting shade of color a colorant provides. In one case, these colorants may produce a substantially saturated spectral response (substantially non-changing) in the absorption band region when applied at an optical density=1.2 or above. This is shown by several colorants in FIG. 5 where the reflectance is substantially the same at wavelength below the “S” shape curve. In another case, these colorants may produce a peak at wavelengths below the “S” shape curve at an OD=1.2 or above. This is also shown by several samples in FIG. 5 where there are peaks in the 400-500 nm region.

The printing industry often uses ISO Status optical density to define a target print density or saturation. Normalized optical density weighting functions, which are not single wavelength but are broad wavelength bands, such as Status T or Status E, are typically used for process printing as the cyan, magenta and yellow colors are utilized and the ISO Spectral Products are specially defined for standard process color printing. For a single wavelength measure the optical density is typically measured at the wavelength of maximum absorption (i.e., the minimum reflectance) or in a narrow band of wavelengths as defined in ISO Status NB and is calculated as the base 10 logarithm of the reciprocal of the minimum reflectance, where the reflectance is (% Reflectance)/100. As the present invention defines non-standard colors to define new process printing color sets, the optical density is calculated at the single wavelength of minimum reflectance. The color and spectral features for the present invention are determined at an optical density equal to 1.20. To minimize the impact of haze and gloss differences between samples, the optical density is measured using a diffuse sphere spectrophotometer using the specular included instrument setting instead of the bidirectional instrument defined in the ISO 5 standard on measuring optical density.

The material onto which a toner, ink or paint is applied in use may vary and impacts the spectral response. Common substrates include but are not limited to various types of cardboard, paper and film, which may be coated with any number of materials known in the art, may be of a single or multiple layer construction, and may be of any color. The Leneta 3NT-31 stock has been used in this invention to measure a standardized color response for the colors.

An ink formulation is prepared for the examples by charging pigment (20 grams) to a solvent-based ink grind vehicle (80 grams) containing 28% by weight of commercial grade ethanol soluble nitrocellulose resin and ⅛ inch stainless steel balls (300 grams) to a 16 oz glass jar. This mixture is agitated for 30 minutes using a paint shaker to produce a millbase. The finished ink is prepared by letting back the millbase (50 grams) with additional letdown vehicle (50 grams) containing 44% by weight commercial grade ethanol soluble nitrocellulose. The ink is then mixed and strained to remove the steel balls and the viscosity of the ink was reduced to 15-16 seconds, as measured with a #3 Zahn Cup, by adding ethonal as solvent. The ink is then printed using a laboratory flexo proofer to produce dried ink films of an appropriate thickness with one within the targeted OD range from 1.1-1.3.

The type of colorimeter and the setting under which the spectral response is measured also impacts the spectral response. The Spectraflash 600 diffuse sphere spectrocolorimeter from Datacolor is used to measure the spectral response at 10 nm intervals with the Large Area View and Specular Included instrument settings used.

The Mid-Point Wavelength (MPW), which is close to the inflection point of the “S” curve, is used to define the color in the present invention. The MPW is defined as the wavelength at which the spectral response crosses the mid-point percent reflectance (MP % R). The MP % R is defined as the mid-point between the Average Substrate % R (AS % R) for the substrate used in the substantially non-absorption wavelength band region for the colorant of the Leneta 3NT-31 substrate, and the minimum % R of 6.31, which is the reflectance at an OD of 1.20. The MP % R may be calculated from the following equation:

MP% R=((AS% R−6.31)/2)+6.31

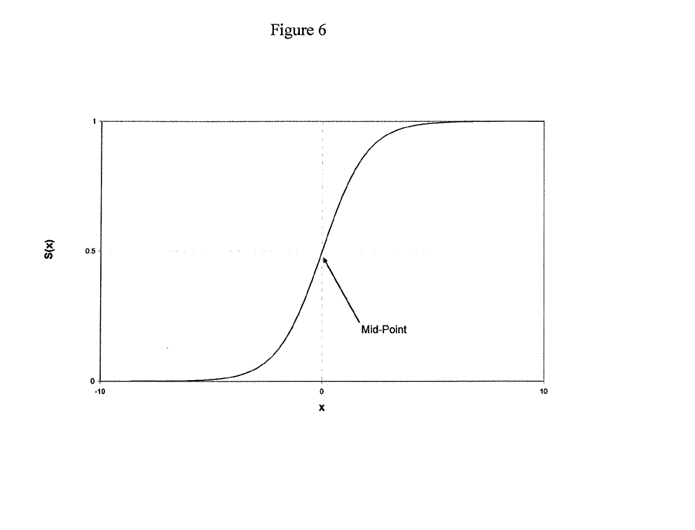

The AS % R is the average % R for the substrate, Leneta 3NT-31, from the Lower Wavelength Limit (LWL) to the Upper Wavelength Limit (UWL) in the non-absorption wavelength region of the spectral response. The Upper Wavelength Limit of the non-absorption region is set at 700 nm for all colors having the “S” shape curve. The Lower Wavelength Limit of the non-absorption region varies from colorant to colorant and is determined as the point where the spectral response substantially reaches or for substantially fluorescent materials crosses the response of the substrate. The AS % R and MP % R as a function of LWLs from 410-700 nm are shown in Table 4 and vary only a small amount between 46.20 and 47.46. The MPW determined from the MP % R is utilized to standardize the determination of this key spectral feature as the spectral responses may sometimes be distorted from perfect “S” shape curve. For example asymmetric curves may lead to significant changes in the mathematically defined inflection point but not the observed color. Also factors such as significant fluorescence may result in a peak above the substrate response in the non-absorption region of the colorant and distort the inflection region, and significant levels of bronzing or scattering may also distort away from the somewhat symmetric nature of the “S” curves observed in FIG. 6.

TABLE 4
The AS % R and MP % R as a function
of LWLs from 410-700 nm.

| | Leneta | | |
|---|---|---|---|
| Wavelength | 3NT-31 | AS % R | MP % R |
| (nm) | (% R) | (% R) | (% R) |
| 400 | 52.56 | — | — |
| 410 | 70.79 | 86.12 | 46.22 |
| 420 | 88.24 | 86.65 | 46.48 |
| 430 | 89.48 | 86.59 | 46.45 |
| 440 | 90.05 | 86.49 | 46.40 |
| 450 | 88.88 | 86.35 | 46.33 |
| 460 | 87.32 | 86.25 | 46.28 |
| 470 | 86.96 | 86.20 | 46.26 |
| 480 | 87.04 | 86.17 | 46.24 |
| 490 | 86.58 | 86.13 | 46.22 |
| 500 | 86.33 | 86.11 | 46.21 |
| 510 | 85.84 | 86.10 | 46.20 |
| 520 | 85.25 | 86.11 | 46.21 |
| 530 | 84.75 | 86.16 | 46.24 |
| 540 | 84.52 | 86.24 | 46.28 |
| 550 | 84.51 | 86.35 | 46.33 |
| 560 | 84.46 | 86.47 | 46.39 |
| 570 | 84.71 | 86.62 | 46.46 |
| 580 | 85.08 | 86.77 | 46.54 |
| 590 | 85.38 | 86.91 | 46.61 |
| 600 | 85.51 | 87.04 | 46.68 |
| 610 | 85.54 | 87.20 | 46.75 |
| 620 | 85.60 | 87.38 | 46.85 |
| 630 | 85.94 | 87.61 | 46.96 |
| 640 | 86.55 | 87.84 | 47.08 |
| 650 | 87.29 | 88.06 | 47.18 |
| 660 | 87.80 | 88.21 | 47.26 |
| 670 | 88.00 | 88.32 | 47.31 |
| 680 | 88.25 | 88.42 | 47.37 |
| 690 | 88.40 | 88.51 | 47.41 |
| 700 | 88.61 | 88.61 | 47.46 |

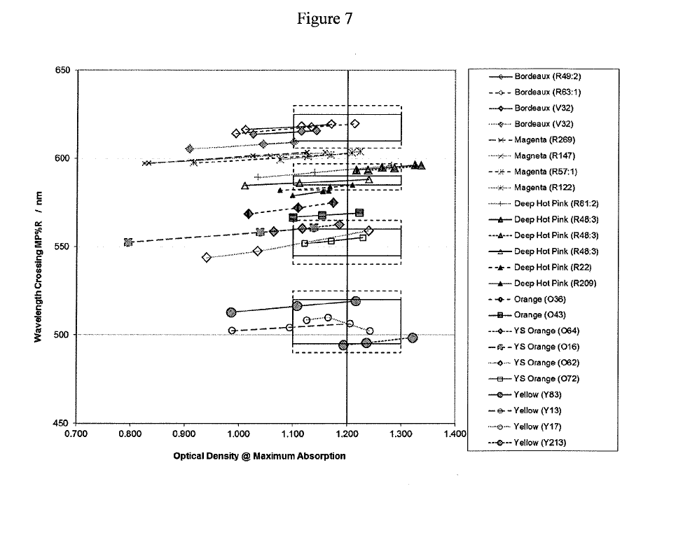

The MPW for the present invention are determined at an optical density of 1.20. The point that a spectral response curve crosses the MP % R is calculated by performing a linear regression for the wavelength and % Reflectance for the points in the curve occurring just prior to and just after the curve crosses the MP % R and then entering the MP % R value as the % Reflectance into the linear model to calculate the wavelength at which the spectral response equals the MP % R. This is performed on each spectral response. The MPW for the colorant may be determined by one of three methods: one direct, two interpolation and three extrapolation. For the direct method one print is prepared at the target optical density of 1.20±0.01 and the MPW is calculated directly as the wavelength that crosses the spectral response at the MP % R. For the interpolation method three prints with different optical densities are prepared with at least one above and one below the target optical density and with at least one from 1.1-1.3, the wavelength that each spectral response crosses the MP % R is calculated as described above, a further linear regression is performed for the three optical densities and associated wavelengths that cross the MP % R, and then the OD of 1.2 is entered into this model to calculate the MPW. For the extrapolation method three prints with different optical densities are prepared on one side of the optical density target with the one from 1.1-1.3, the wavelength that each spectral response crosses the MP % R is calculated as described above, a further linear regression is performed for the three optical densities and associated wavelengths that cross the MP % R, and then the OD of 1.2 is entered into this model to calculate the MPW. Typically the wavelengths that cross the MP % R are a linear function of optical density as shown in FIG. 7, thus interpolation and extrapolation using a linear model provides an accurate value. If for a colorant the three points do not form a straight line, higher order models may be used to better extrapolate or interpolate of the value for an optical density of 1.20. In the case of severe non-linearity the direct method should be used.

A unique process color set provided by the present invention is defined by the location and separation of the Mid-Point Wavelength of the colors. By providing a similar separation between adjacent colors, overall cleaner shades can be prepared when trapping two or more colors compared to the prior art. Cleaner red shade yellows are obtained when trapping the yellow with a yellow shade orange than with an orange or reds. By selection of a bordeaux, cleaner dark reds are obtained than by trapping a black, green or other color with a magenta, which lowers the overall reflectance in the 600-700 nm region.

Two colors with “S” shape curves produce, cleaner trapped colors when the MPWs are closer together. This is observed when one color is printed at high optical density and the adjacent color with a higher MPW is printed at a lower optical density to produce the third trapped color. When comparing colors, the dirtier color typically yields a broader shoulders in the spectral response that extend to higher wavelengths, while the cleaner trapped color has a less broad shoulder. An overall cleaner trapped color set is thus obtained when the separation between all of the adjacent “S” shape curve color pairs is the same. The separation is determined by the distance between the “S” shape curve colors with the highest and lowest MPWs, typically the lowest is a shade of yellow and the highest a bordeaux, preferably the lowest is a shade of yellow and the highest a bordeaux. When the difference between the minimum and maximum separation is large, the adjacent colors with the smaller separation in MPWs when combined provide some cleaner trapped colors than the present invention but the adjacent colors with the larger separation in MPWs when combined will produce dirtier colors.

The color of colorants at an OD=1.2 have been defined by the position of the “S” shape curve, which are quantified by the MPW. The position of the “S” shape curve is determined by the placement of the absorption band of the colorant along the electromagnetic spectrum. The absorption band may be mono-, bi-, tri- or multi-modal with the maximum in the absorption band determining the region where the single wavelength OD is typically measured at minimum reflectance and with the transition from this maximum to the high wavelength, lower energy tail of the absorption band determining the “S” shape curve transition from lower reflectance at shorter wavelengths to high reflectance at longer wavelengths. The modal nature and breadth of the tail of the absorption band and the direct impact that these have on the spectral response are dependent on the chemistry and physics of the colorant and the film containing the colorant.

Colors not obtained from the individual colors are obtained when two or more colors are combined. When a first color a yellow color at an OD=1.2 for the present invention is combined with a second color another ink having a similar “S” shape curve with a MPW in the yellow shade orange region or above, to produce red shade yellows, the cleanest colors and highest gamuts near the yellow are obtained for the lowest MPW yellow shade oranges and become dirtier colors with lower gamut near the yellow as the MPW increases for the second color. In a similar manner, when a yellow shade orange color at an OD=1.2 for the present invention is combined with another ink having a similar “S” shape curve with a higher MPW in the Deep Hot Pink region or above to produce oranges, the cleanest colors and highest gamuts near the yellow shade orange are obtained with the lowest MPW Deep Hot Pinks and become dirtier colors with lower gamut near the yellow shade orange as the MPW increases. The key factor in determining how clean or dirter combined colors are is the spacing between the MPWs of the two inks, thus evenly separating the four colors with “S” shape curves in a 6-Color Set will produce the overall most uniform cleaner colors. Individually cleaner combined colors may be obtained by moving two MPWs closer together but that will further separate two other MPWs resulting in those two producing relatively dirter colors. For example, cleaner and higher gamut red shade yellows may be produced by combining a yellow with an even redder shade yellow or cleaner and higher gamut oranges may be produced by combining a yellow shade orange with a bluer shade orange. Narrowing the distance between the two adjacent colors increases the cleanness and gamut in some regions of color space, but in other regions the cleanness and gamut are decreased.

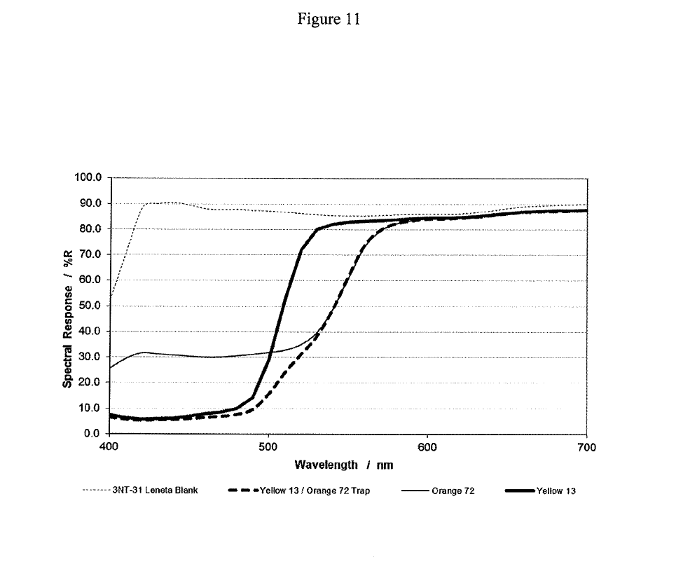

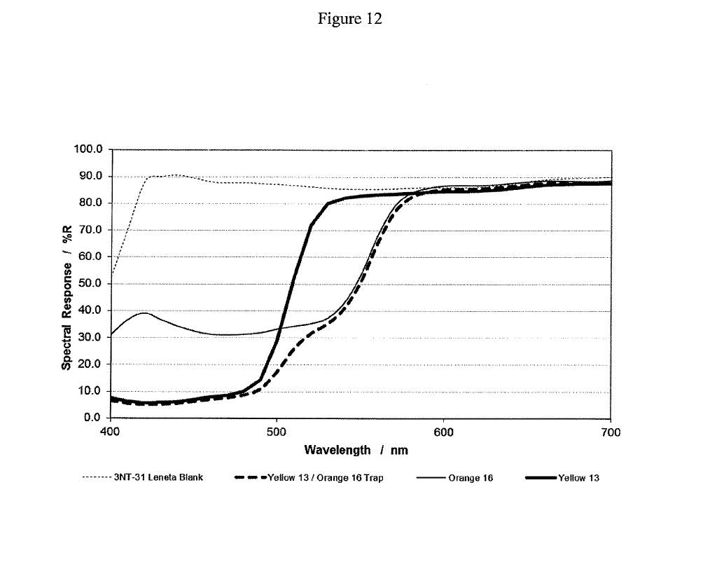

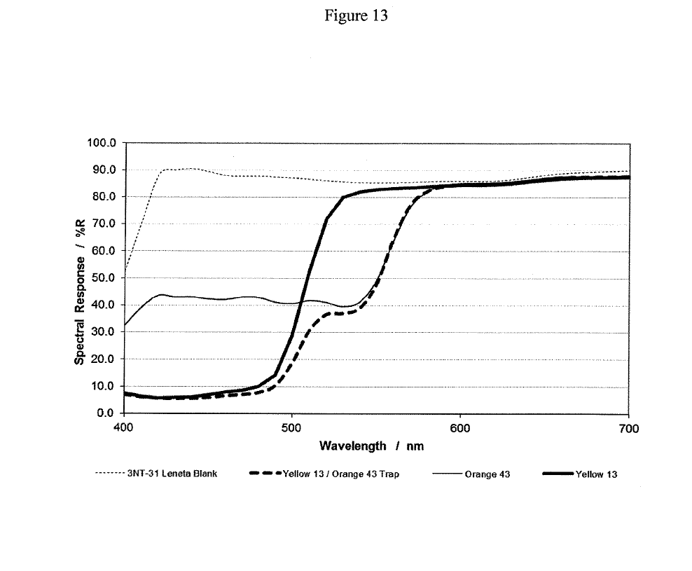

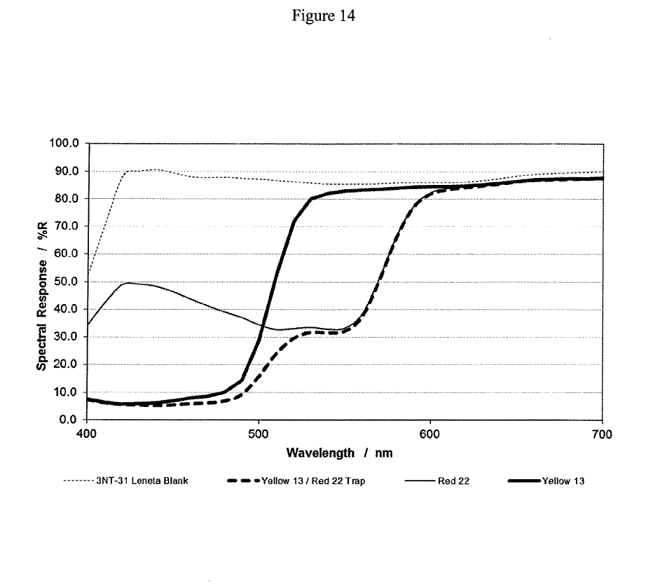

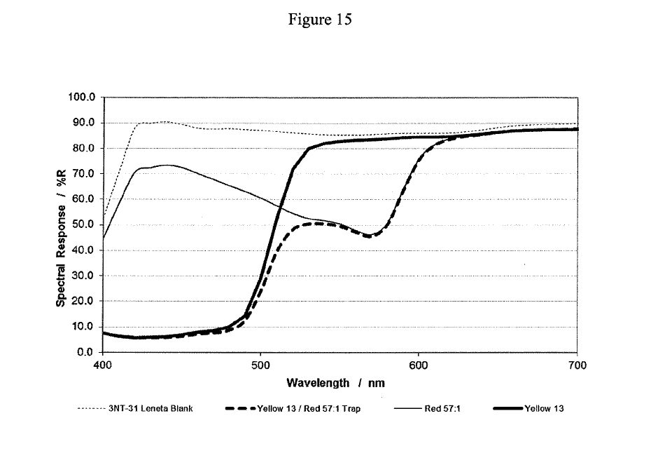

The impact of MPW separation is observed in the following example. A first color yellow ink (C.I. Pigment Yellow 13) with an MPW=505.6 was prepared by the described method, printed at an OD≈1.2 and then overprinted with a second color, five different second colored inks were used having MPWs of 554.2, 562.0, 568.7, 584.6 and 602.8, made from a yellow shade orange (C.I. Pigment Orange 72), a yellow shade orange pigment (C.I. Pigment Orange 16), an orange (C.I. Pigment Orange 43), a deep hot pink (C.I. Pigment Red 22) and a magenta (C.I. Pigment Red 57:1), respectively. The yellows were overprinted with the second color at a thinner film thickness than needed to obtain an OD of 1.2 to produce the trapped colors (FIGS. 11-15). The dirtiest of the combined prints was from the magenta made with the C.I. Pigment Red 57:1 (FIG. 15) and the cleanest was from the yellow shade red made from C.I. Pigment Orange 72 (FIG. 11). The dirtiness from the magenta is a result of the broad shoulder and dip in the spectral response while the cleanest is produced from the yellow shade orange which produces the smallest shoulder. It is readily seen that a further separation between two MPWs produces broader shoulders and dirtier trapped colors.

Many different methods may be used to produce the final film, which may be printing with methods including but limited to letterpress, flexography, offset lithography, gravure, screen printing, heat transfer, digital or combination of methods in hybrid systems; digital printing system include but are not limited to electronic, inkjet, elctrophotographic, ion deposition, magnetographic and thermal transfer; coating; or painting. The form of the carrier vehicle for the colorant at ambient temperature may be a solid, including but not limited to a type of wax, plastic, polymer or any combination of these; or a higher viscosity paste or lower viscosity fluid type of liquid. The non-colorant portions may or may not contain water. The non-colorant portion may contain several organic compounds that are dissolved, emulsified, dispersed, suspended or any combination of these in the carrier vehicle continuous phase. The continuous phase includes all of the following but is not limited to solvents both organic solvents and water as a solvent that may be absorb into the substrate or be evaporated for drying processes; to reactive materials that that are cured by thermal, radiation (including ultraviolet or electron beam), oxidative or other curing processes; to meltable materials for thermal transfer systems such as waxes; or any combination of these. The reactive materials include but are not limited to monomers, oligomers or higher molecular weight reactive polymers. When the film is set by curing polymerization initiators are typically added that facilitate the polymerization of the reactive materials. The organic materials may each be of polar, non-polar, or have two or more portions of a material that have different polarities. The organic material may perform many functions including but not limited to being a humectant, charging agent, surfactant, defoamer, hydrotrope, dispersant, synergist, slip agent, wax, coalescing agent, leveling agent, wetting agent, thickener, antistat, glide agent, flow agent, deaerator, binder, film forming resin, extender, biocide, fungicide, initiator, accelerator, adhesion promoter, anti-fouling agent, anti-graffiti, anti-settling agent, anti-skinning agent, catalyst, diluent, drier, drying agent, drying oil, filler, retarder, sealer, thinner, thixotrope or hydrophobic agent. The colors may be combined in separate or combined layers or a combination with the same or differing thickness, complete or partial mixing may occur prior to reaching the final physical form either prior, during or after application, the layer or layers may be of complete or partial coverage or a combination, the partial coverage or coverages may be of the same or differing patterns, percent of coverage and varying overlap. When the colored film is an ink film the ink may be a single purpose inks that are used for either surface printing or lamination printing. The 6-color set of the present invention with the overall improved color space is preferred for multi-purpose inks that are designed for use for both surface and lamination inks.

The darker red colors are observed from bordeaux rather than magenta colors designated for example from either C.I. Pigment Red or C.I. Pigment Violet colorants. The first color being magenta and bordeaux colors have a secondary spectral feature of a peak from 400-550 nm which impart the blue hue to the color. When the peak is substantially reduced by trapping with a second color of any shade of yellow or orange the higher the MPW of the first magenta or bordeaux color the darker the shade of red when these “S” shape curve have similar shapes as shown in FIG. 5. To produce darker red with the various magenta colors which have lower MPWs than the bordeaux, the spectral response in the high wavelength region from 600-700 nm is lowered by trapping with a third color for example with a black, cyan, blue, green or violet color that substantially absorb light in that region. This process suppresses responses in the 600-700 nm regions and produces dirtier shades of dark red.

For the purposes of the present invention, the colors with “S” shape curves as the predominant spectral feature are defined by the ranges of Mid-Point Wavelengths as shown in Table 5a and the colors with peaks as the predominant spectral feature are defined by the ranges of Peak Maximum Wavelengths as shown in Table 5b.

TABLE 5a
Mid-Point Wavelengths of various colors.

| | Preferred | |
|---|---|---|
| | Range | Range |
| Color | for MPW | for MPW |
| Yellow | 495-520 | 490-525 |
| Yellow Shade Orange | 545-560 | 540-565 |
| Orange | — | >565-577 |
| Yellow Shade Red | — | >577-<582 |
| Deep Hot Pink | 585-590 | 582-597 |
| Blue Shade Red | — | >597-<600 |
| Magenta | — | 600-<606 |
| Bordeaux | 610-625 | 606-630 |

TABLE 5b
Peak Maximim Wavelengths of various colors.

| | Range for |
|---|---|
| Color | Peak Maximum |
| Green | >480-550 |
| Cyan | >470-480 |
| Blue | >450-470 |
| Violet | 400-450 |

The bordeaux color having the highest MPW may be obtained from several colorants including but not limited to C.I. Pigment Violet 32, C.I. Pigment Red 63:1 and C.I. Pigment Red 49:2. The Bordeaux color provides a MPW from 606-630 nm, preferably from 610-625 nm. The MPW for the Bordeaux is higher than that observed for a Magenta color. The MPW was determined for several colorants typically used in the graphics art and publishing industries to prepare magenta colors used for process color printing. The MPW for these commercial C.I. Pigment Red colorants used as magentas in the current art (not necessarily as magentas for the purpose of the present invention) are shown in Table 1, which are colorants typically used for 3 and 4 color process printing.

C.I. Pigment Red colorants classified as magenta according to the present invention and used in conventional process color printing include but are not limited to C.I. Pigment Red 23, C.I. Pigment Red 52:1, C.I. Pigment Red 122, C.I. Pigment Red 147, C.I. Pigment Red 184, C.I. Pigment Red 185 and C.I. Pigment Red 269. The most common pigment used for the magenta colored ink in commercial printing is C.I. Pigment Red 57:1 which has a MPW of ˜603 nm. The bordeaux, magenta, blue shade red & deep hot pink colorant may also have a peak with a maximum from 400-550 nm, which becomes more predominant when printed at lower optical densities. The triarylcarbonium or commonly known as rhodamine based colorants such as C.I. Pigment Red 81:2 have a distinct spectral response, exhibiting higher peaks then many other magenta colorants (see Table 6). Because of the higher level of light observed around the violet region from 400-500 nm for the rhodamine pigment types, the MPW for these are shifted to lower “yellower” red wavelength compared to the other magentas to compensate for the higher violet and provide the perception of magenta. Therefore when preparing various shades of reds by trapping colors, the rhodamine based colorants produce cleaner yellow shade reds, but very dirtier dark reds compared to other magentas. Based on the MPW of 593.6 for the C.I. Pigment Red 81:2 tested, it is considered a deep hot pink color for the purposes of the present invention.

TABLE 6
Mid-Point Wavelengths of Various Colorants
Designated as C.I. Pigment Red.

| Color (Pigment Type) | MPW |
|---|---|
| Deep Hot Pink (R209) | 582.8 |
| Deep Hot Pink (R22) | 584.6 |
| Deep Hot Pink (R48:3 - #1 | 587.4 |
| Deep Hot Pink (R48:3 - #2) | 592.2 |
| Deep Hot Pink (R48:3 - #3) | 593.1 |
| Deep Hot Pink (R81:2) | 593.6 |
| Magenta (R57:1) | 602.8 |
| Magenta (R122) | 603.0 |
| Magenta (R147) | 604.1 |
| Magenta (R269) | 605.1 |
| Bordeaux (R63:1) | 619.4 |
| Bordeaux (R49:2) | 619.9 |

The yellow color having the lowest MPW from the “S” shape curve colors may be obtained from several colorants including but not limited to C.I. Pigment Yellow 1, C.I. Pigment Yellow 2, C.I. Pigment Yellow 3, C.I. Pigment Yellow 5, C.I. Pigment Yellow 6, C.I. Pigment Yellow 49, C.I. Pigment Yellow 65, C.I. Pigment Yellow 73, C.I. Pigment Yellow 12, C.I. Pigment Yellow 13, C.I. Pigment Yellow 14, C.I. Pigment Yellow 74, C.I. Pigment Yellow 75, C.I. Pigment Yellow 97, C.I. Pigment Yellow 111, C.I. Pigment Yellow 116, C.I. Pigment Yellow 167, C.I. Pigment Yellow 203, C.I. Pigment Yellow 114, C.I. Pigment Yellow 126, C.I. Pigment Yellow 127, C.I. Pigment Yellow 174, C.I. Pigment Yellow 176, C.I. Pigment Yellow 188, C.I. Pigment Yellow 83, and C.I. Pigment Yellow 213. The Yellow color includes greener, medium and redder shade yellows. As with the other colors the MPW is measured at the target optical density of 1.2. The Yellow color provides a MPW from 490-525 nm, preferably from 495-520 nm.

The yellow shade orange color may be obtained from several colorants including but not limited to C.I. Pigment Orange 16, C.I. Pigment Orange 62, C.I. Pigment Orange 64 and C.I. Pigment Orange 72. As with the bordeaux the color is defined by the MPW at the target optical density of 1.20. The yellow shade orange color provides a MPW from 540-565 nm, preferably from 545-560 nm.

A deep hot pink color, so named as it lies between the standard named hot pink and deep pink in appearance, is obtained from a colorant that provides a MPW close to mid-way between the bordeaux and yellow shade orange MPWs. The deep hot pink may be obtained from several colorants including but not limited to C.I. Pigment Red 22, C.I. Pigment Red 48:3, C.I. Pigment Red 81:2, and C.I. Pigment Red 209. The deep hot pink color provides a MPW from 582-597 nm, preferably from 585-590 nm.

Two additional chromatic colors with a peak as the predominant spectral feature ranging from violet to green may also be added to make 6-color sets for process printing or color blending.

Two additional colors may be selected for 6 process sets from various shades of Green(G), Cyan(C), Blue(B) or Violet(V). The predominant feature, a peak in the spectral response between 400 and 550 nm, defines the GCBV colors for the present invention. Table 5b shows the peak range for GCBV colors.

Shades of GCBV vary depending on the peak position, breadth, symmetry and other features such as shoulders. Green shades may vary from blue shade greens with lower peak maximums and yellow shade greens with higher peak maximums within the range of Green. Likewise, this includes various shades of Cyan, Blue and Violets having peak maximums within the ranges defined in Table 5b. The green color may be obtained from several colorants or combination of colorants including but not limited to C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45. The cyan or blue may be obtained from several colorants or combination of colorants including but not limited to C.I. Pigment Blue 1, C.I. Pigment Blue 2, C.I. Pigment Blue 9, C.I. Pigment Blue 10, C.I. Pigment Blue 14, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:6, C.I. Pigment Blue 16, C.I. Pigment Blue 18, C.I. Pigment Blue 19, C.I. Pigment Blue 24:1, C.I. Pigment Blue 25, C.I. Pigment Blue 56, C.I. Pigment Blue 60, C.I. Pigment Blue 61, C.I. Pigment Blue 62, C.I. Pigment Blue 63, C.I. Pigment Blue 64, C.I. Pigment Blue 66, C.I. Pigment Blue 75, C.I. Pigment Blue 79, and C.I. Pigment Blue 80. The violet color may be obtain from several colorants or combination of colorants including but not limited to C.I. Pigment Violet 1, C.I. Pigment Violet 3, C.I. Pigment Violet 19, C.I. Pigment Violet 23, and C.I. Pigment Violet 27.

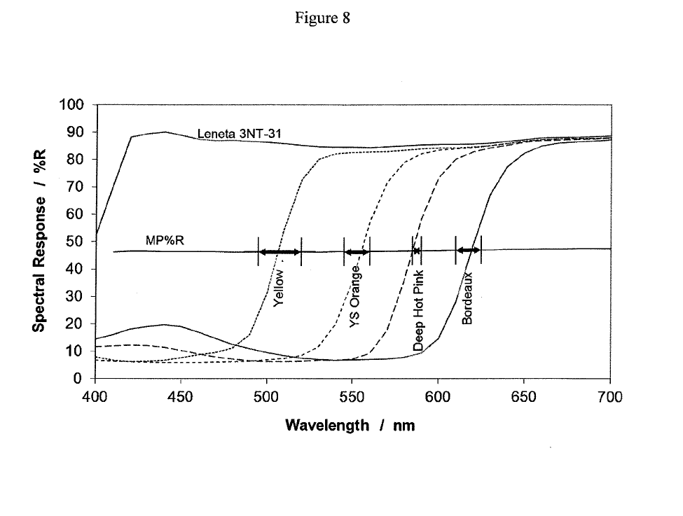

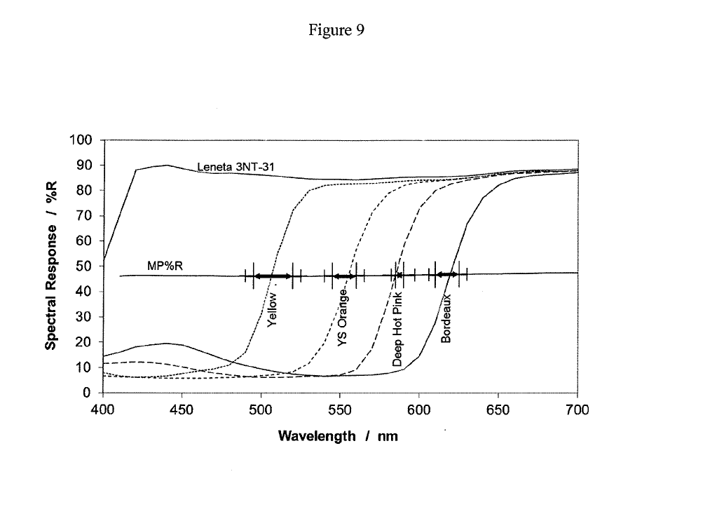

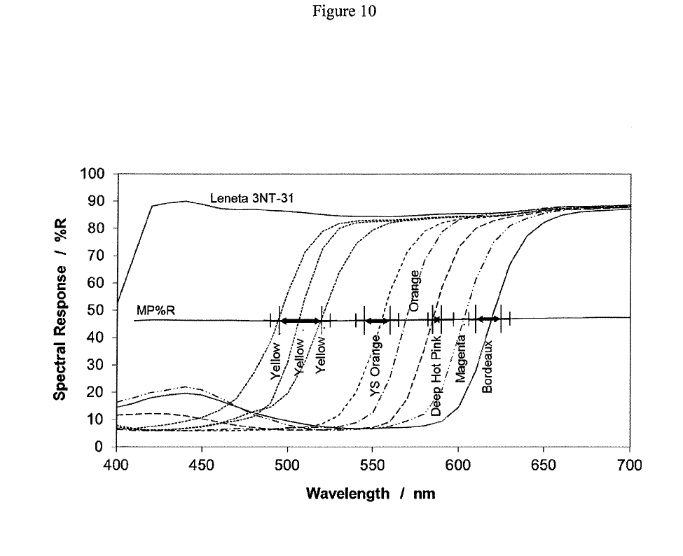

Preferably, the colorants are chosen for the 6 color set so as to provide a relatively even separation between the MPWs. Example sets 1-3 are provided in Table 2 and Example 4 in Table 7, with AMPW(Max-Min) ranging from 2.8-18.6. The spectral response from Example 4 is shown in FIG. 8 for the yellow, yellow shade orange, deep hot pink and bordeaux colors (the spectral response shown is for the print that has an OD closest to the target OD=1.2). Also included in FIG. 8 is the Spectral Response for the Leneta substrate and the calculated MP % R, the point at which the MPW is determined. FIGS. 9 and 10 show the MPW ranges for the colors and the MPW preferred ranges.

TABLE 7
Color set of the present invention with indication of the differences
between the maximum and minimum MPWs (ΔMPW(Max − Min)).

| Invention (Example 4) | MPW | | ΔMPW |
|---|---|---|---|
| Bordeaux (R49:2) | 619.9 | Bordeaux to Deep Hot Pink | 35.3 |
| Bordeaux (V32) | | | |
| Deep Hot Pink (R22) | 584.6 | Deep Hot Pink to YS Orange | 30.4 |
| YS Orange (O72) | 554.2 | YS Orange to Yellow | 47.9 |
| Yellow (Y13) | 506.3 | ΔMPW(Max − Min) = | 17.5 |

| | |
|---|---|
| Green (G7) | Peak Maximum = 501 |
| Blue (B15:3) | Peak Maximum = 467 |

Modifications of specific colorant types may be produced that have different MPWs. If a pigment, the colorant may have different particle size or particle size distributions, crystal morphologies, degree of aggregation, or additional colored material to act as surface modifiers, crystal growth inhibitors, contribute to a solid solution to name a few that may change the MPWs. The present invention defines the color by the MPW not by the colorant type, class or other designation as two colorants provided as the same type or class of colorant may produce different colors under the scope of this invention. Other parameters such as transparency and gloss may also have an impact.

These colors may be used by applying one layer over another for any printing system including but not limited to letterpress, flexography, offset lithography, gravure, screen printing, heat transfer, digital or combination of methods in hybrid systems; digital printing system include but are not limited to electronic, inkjet, elctrophotographic, ion deposition, magnetographic and thermal transfer.

The color set of the present invention may be used in a blending system to produce specific colors for use in paints and coatings, such as architectural paints, or a line or spot color printing. Color separations may be accomplished by methods known in the art.

The present invention has been described in detail, including the preferred embodiments thereof. However, it will be appreciated that those skilled in the art, upon consideration of the present disclosure, may make modifications and/or improvements on this invention that fall within the scope and spirit of the invention.

All references cited herein are herein incorporated by reference in their entirety for all purposes.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the invention.

1. A 6-Color Set of chromatic primary colors comprising:
(a) a bordeaux color and/or a yellow shade orange color; and
(b) a number of other colors in order to have a total of 6 colors in the set,
wherein magenta is not one of the chromatic primary colors and the 6-Color Set is suited for subtractive color combinations.

2. The 6-Color Set of claim 1, wherein the bordeaux color provides a Mid-Point Wavelength between 610 and 625 nm.

3. The 6-Color Set of claim 1 comprising both the bordeaux color and the yellow shade orange color.

4. The 6-Color Set of claim 1, wherein the other colors are a deep hot pink, a yellow, and other colors selected from the group consisting of: a green color, a cyan color, a blue color and a violet color.

5. The 6-Color Set of claim 1 comprising 4 colors with predominately “S” curve spectral response features with ΔMPW(Max-Min) less than 35.

6. The 6-Color Set of claim 1 comprising 4 colors with predominately “S” curve spectral response features with ΔMPW(Max-Min) less than 20.

7. The 6-Color Set of claim 1 comprising 4 colors with predominately “S” curve spectral response features with ΔMPW(Max-Min) less than 10.

8. The 6-Color Set of claim 1 further comprising at least one achromatic color.

9. The 6-Color Set of claim 1, wherein the yellow shade orange color provides a Mid-Point Wavelength between 545 and 560 nm.

10. The 6-Color Set of claim 1, wherein Deep Hot Pink is not one of the chromatic primary colors.

11. The 6-Color Set of claim 1, wherein a chromatic color having a Mid-Point Wavelength between 590 and 600 nm is not one of the chromatic primary colors.

12. A color application process comprising generating various colored materials using the 6-Color Set of claim 1.

13. The color application process of claim 12, in which the process is selected from the group consisting of: printing, painting and coating application.

14. The color application process of claim 12, in which the process is a printing process selected from the group consisting of: digital, inkjet, electrophotographic, flexographic, gravure, offset lithographic, screen and a combination process thereof.

15. The color application process of claim 14, in which the printing process comprises multi-purpose inks.

16. An article prepared by using the process of claim 12.

17. A method of modifying the color gamut of a color application process that employs a 6-Color Set of chromatic primary colors comprising modifying the 6-Color Set to exclude Magenta color and add a bordeaux color and/or a yellow shade orange color.

18. The method of claim 17, wherein the modified 6-Color Set of primary colors further comprise at least one achromatic color.

19. The method of claim 17, wherein the bordeaux color provides a Mid-Point Wavelength between 610 and 625 nm.

20. The method of claim 17, wherein the yellow shade orange color provides a Mid-Point Wavelength between 545 and 560 nm.

21. The method of claim 17, wherein Deep Hot Pink is excluded as one of the chromatic primary colors.

22. The method of claim 17, wherein a chromatic color having a Mid-Point Wavelength between 590 and 600 nm is not one of the chromatic primary colors.
